(19) United States
(12) Patent Application Publication
(10) Pub. No.: US 2025/0347789 A1
(43) Pub. Date: Nov. 13, 2025

(54) DISTANCE MEASURING APPARATUS

(71) Applicant: Stanley Electric Co., Ltd., Tokyo (JP)

(72) Inventor: Atsuhiko CHIKAOKA, Tokyo (JP)

(73) Assignee: Stanley Electric Co., Ltd., Tokyo (JP)

(21) Appl. No.: 19/203,261

(22) Filed: May 9, 2025

(30) Foreign Application Priority Data
May 10, 2024 (JP) 2024-077445

(51) Int. Cl. G01S 7/497; G01S 7/481; G01S 7/484; G01S 7/4863; G01S 7/4865; G01S 17/10

(52) U.S. Cl. CPC G01S 7/4972; G01S 7/4817; G01S 7/484; G01S 7/4863; G01S 7/4865; G01S 17/10

(57) ABSTRACT

A distance measurement apparatus including: a light source that emits a laser beam; a deflector that deflects the laser beam emitted from the light source; a light receiving sensor that receives a reflected light generated when the laser beam is irradiated onto an object; and a controller that controls the light source and the deflector and measures the distance between the object based on the reflected light, where the controller detects a control deviation of the deflector based on a difference between a reference light entrance position of the laser beam on the light receiving surface of the light receiving sensor assumed for a rotation angle being set in the deflector and an actual light entrance position of the laser beam at the light receiving sensor determined based on the reflected light generated by actually operating the deflector at the rotation angle being set to deflect the laser beam.

### CROSS-REFERENCE TO RELATED APPLICATION

The present application is based on, and claims priority from, JP Application Serial Number, 2024-077445 filed on May 10, 2024, the disclosure of which is hereby incorporated by reference herein in its entirety.

### BACKGROUND

### Technical Field

The present disclosure relates to a distance measuring apparatus.

### Description of the Background Art

An apparatus that detects an object by irradiating a laser beam and detecting its reflected light is known. For example, Japanese Unexamined Patent Application Publication No. 2017-72532 (Patent Document 1) describes a distance measuring apparatus characterized by having a light projecting unit that projects a laser beam, a light receiving element array in which a plurality of light receiving elements are arranged, a focusing lens that focuses light on the light receiving element array, a detection unit that detects the output of one or more of the light receiving elements of the light receiving element array, and a selection unit that selects the light receiving element to be output to the detection unit depending on the incident angle of the reflected light from a target object corresponding to the projection angle of the laser beam to the focusing lens, in consideration of the distortion of the irradiation range of the laser beam in the light receiving element array when the projection angle increases.

In the distance measuring apparatus like the one described above, a deflector is used to scan a space with the laser beam, and in such a case, deviation may occur between the drive angle specified for the deflection angle and the actual drive angle due to factors such as usage environment (temperature, air pressure, etc.) and deterioration over time. Such differences can cause a decrease in distance measuring performance.

With respect to such issue, for example, Japanese Unexamined Patent Application Publication No. 2016-31236 (Patent Document 2) describes a laser radar device in which a window where a plurality of markers that reflect a laser beam is arranged is disposed at a position where the laser beam passes, distance values and position coordinates of the plurality of markers are obtained from a distance intensity image obtained by distance measurement, and installation position and installation angle of a scanner (a deflector) is specified based on the obtained values, etc., thereby enabling calibration of the scanner.

However, since this laser radar device has the plurality of markers on the path of the laser beam, there are places where the laser beam is blocked by the markers, which creates blind spots or directions with poor distance measurement performance, which leads to a decrease in distance measurement performance, thereby it is considered that there is room for improvement.

In a specific aspect, in a distance measurement apparatus using a laser beam, it is an object of the present disclosure to provide a technology that enables to suppress a decrease in distance measurement performance with a simple configuration and to maintain an appropriate distance measurement range.

### SUMMARY

A distance measurement apparatus according to one aspect of the present disclosure is a distance measurement apparatus for measuring a distance between the apparatus and an object including: a light source that emits a laser beam; a deflector that deflects the laser beam emitted from the light source; a light receiving sensor that receives a reflected light generated when the laser beam deflected by the deflector is irradiated onto the object; and a controller that controls the operation of the light source and the deflector and measures the distance between the object based on the reflected light received by the light receiving sensor, where the controller detects a control deviation of the deflector based on a difference between a reference light entrance position of the laser beam on the light receiving surface of the light receiving sensor that is assumed for a rotation angle being set in the deflector and an actual light entrance position of the laser beam at the light receiving sensor that is determined based on the reflected light generated by actually operating the deflector at the rotation angle being set to deflect the laser beam.

According to the above configuration, in a distance measurement apparatus using a laser beam, it is possible to suppress a decrease in distance measurement performance with a simple configuration and to maintain an appropriate distance measurement range.

### BRIEF DESCRIPTION OF THE DRAWINGS

FIG. 1 is a diagram showing the configuration of a distance measurement apparatus according to one embodiment.

FIG. 2 is a diagram for explaining an example of the arrangement of the light source unit and the light receiving unit, and the light receiving visual field.

FIG. 3 is a diagram for explaining the predetermined rotation angle of the MEMS mirror.

FIG. 4 is a diagram for explaining the setting content of the rotation angle.

FIG. 5 is a flowchart showing the processing content for detecting deviation in the deflection angle and correcting the drive angle based on the detection results.

FIG. 6 is a diagram showing the coordinate system of the MEMS mirror, the lens, and the light receiving sensor.

FIG. 7 is a diagram for explaining the plurality of light receiving units of the light receiving sensor.

FIG. 8 is a flowchart for explaining the detailed processing content of step S6 in FIG. 5 described above.

FIG. 9 is a schematic diagram showing the flight path of the emitted light in an ideal state and the flight path of the emitted light when the rotation angle is deviated in the V-axis direction.

FIG. 10 is a diagram showing the relationship between flight distance D of the flight path of the emitted light illustrated in FIG. 9 and the position of the light receiving sensor that receives the reflected light.

FIG. 11 is a schematic diagram showing the flight path of the emitted light in an ideal state and the flight path of the emitted light when the rotation angle is deviated in the H-axis direction.

FIG. 12 is a diagram showing the relationship between the flight distance D of the flight path of the emitted light illustrated in FIG. 10 and the position of the light receiving sensor that receives the reflected light.

FIG. 13A is a diagram for explaining the measurement range in the first embodiment as a comparative example, and FIG. 13B is a diagram for explaining the measurement range in the second embodiment.

FIG. 14A is a diagram for explaining the measurement range in the first embodiment as a comparative example, and FIG. 14B is a diagram for explaining the measurement range in the second embodiment.

FIG. 15 is a diagram for explaining the transition of the emitted light.

FIG. 16 is a diagram illustrating the relationship between the flight distance and the light receiving position of the light receiving sensor.

FIG. 17 is a flowchart for explaining detailed processing content according to the third embodiment.

FIG. 18 is a flowchart for explaining detailed processing content according to the fourth embodiment.

### DESCRIPTION OF THE PREFERRED EMBODIMENTS

### First embodiment

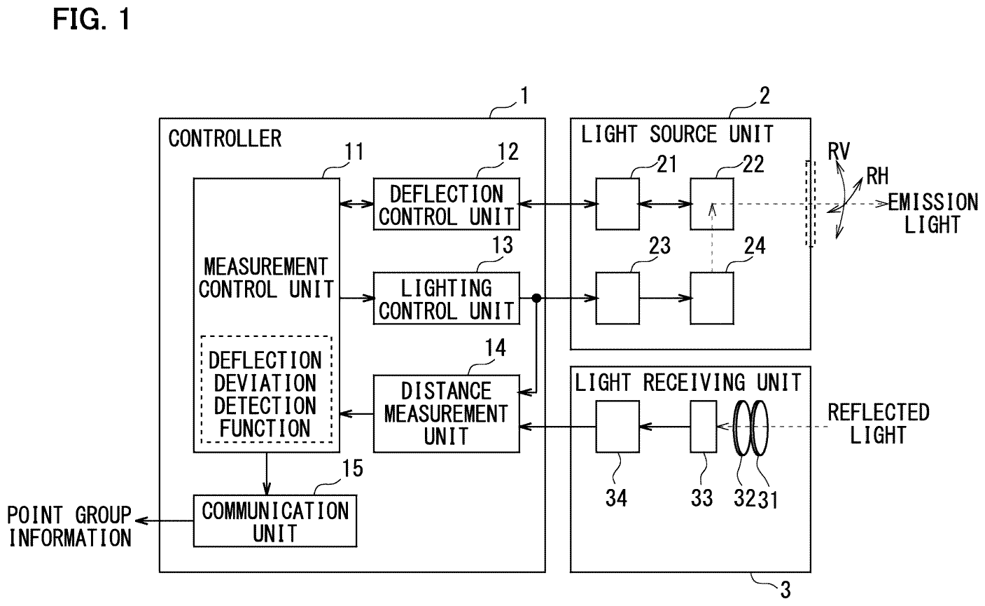

FIG. 1 is a diagram showing the configuration of a distance measurement apparatus according to a first embodiment. The distance measurement apparatus (object detection apparatus) of the present embodiment is designed to perform optical scanning of a target space using emitted light, which is a laser beam, and receive reflected light, and to detect the position and relative distance of an object present in the target space using the reflected light, and is configured to include a control unit (controller) 1, a light source unit 2, and a light receiving unit 3.

Control unit 1 controls the overall operation of the distance measurement apparatus, and is configured to include a measurement control unit 11, a deflection control unit 12, a lighting control unit 13, a distance measurement unit 14, and a communication unit 15. This control unit 1 can be realized, for example, by using a computer system equipped with a CPU, ROM, RAM, etc., and having the computer system execute a predetermined operation program.

Measurement control unit 11 controls the operation of deflection control unit 12, lighting control unit 13, and distance measurement unit 14. Further, measurement control unit 11 has a function of detecting deviations in deflection control (deflection deviation detection function) based on the relationship between the light receiving position relative to the deflection condition of the emitted light and the measured distance.

Deflection control unit 12 controls a MEMS mirror 22 via a MEMS driver 21 of light source unit 2 so that it periodically deflects in a specified angle change pattern (typically a raster scan with evenly spaced scan lines).

Lighting control unit 13 controls a light source 24 via a light source driver 23 so that the light source 24 emits laser beam under the pulse condition specified by measurement control unit 11.

Distance measurement unit 14 measures the distance between an object in the target space based on the time difference between the time of emission and the time of reception of the emitted light, using the time of instruction to generate the emitted light by lighting control unit 13 and the light receiving signal obtained from a light receiving circuit 34 of light receiving unit 3. Further, a three-dimensional position of the object is detected by measurement control unit 11 based on the time of emission and the time of reception of the emitted light.

Communication unit 15 receives point group information (a collection of three-dimensional positions) obtained by distance measurement unit 14 from measurement control unit 11, and transmits this point group information to an external device (not shown).

Light source unit 2 generates emission light (emitted light), which is a narrow-angle beam of laser beam, and emits it in various directions within a predetermined range, and it is configured to include the MEMS driver 21, the MEMS mirror 22, the light source driver 23, and the light source 24.

MEMS driver 21 is connected to MEMS mirror 22, and under the control of deflection control unit 12 of control unit 1, generates a drive signal that controls the operation of MEMS mirror 22 and supplies it to MEMS mirror 22.

MEMS mirror 22 has a reflective surface and is configured to be rotatable about two orthogonal axial directions and it is a two-dimensional deflector that deflects the laser beam emitted from light source 24. In this MEMS mirror 22, its first axis rotates in a resonant manner and its second axis which is orthogonal to its first axis rotates in a non-resonant manner. This MEMS mirror 22 rotates based on a drive signal supplied from MEMS driver 21, thereby scanning the emitted light along the two directions within the target space. The emitted light t is emitted from an opening appropriately provided in light source unit 2 to the external target space. In the figure, RH indicates the deflection direction caused by the rotation of MEMS mirror 22 in the main axis (first axis) direction, and RV indicates the deflection direction caused by the rotation of MEMS mirror 22 in the secondary axis (second axis) direction.

Light source driver 23 is connected to light source 24, and under the control of lighting control unit 13 of control unit 1, generates a drive signal that controls the operation of light source 24 and supplies it to light source 24.

Light source 24 generates emission light (emitted light), which is a laser beam with a small divergence angle, and emits it to MEMS mirror 22. The laser beam emitted from light source 24 is a beam with a divergence angle that is comparable to (the same as or smaller than) the angular resolution of the distance measurement apparatus. Light source 24 may be, for example, a near-infrared photonic crystal laser (PCSEL), but is not limited thereto, and any light source capable of emitting a narrow-angle beam of laser beam may be used. The laser beam emitted from light source 24 may be, for example, a pulsed beam with a wavelength of 940 nm and a divergence angle of 0.1°.

Light receiving unit 3 receives reflected light generated when the emitted light is irradiated to an object, and generates a light receiving signal, and it is configured to include a lens 31, an optical filter 32, a light receiving sensor 33, and the light receiving circuit 34.

Lens 31 collects the reflected light that occurs when the emitted light emitted from light source 24 is irradiated to an object.

Optical filter 32 blocks light in a wavelength range different from that of the emitted light and transmits light which has the same wavelength range as the emitted light.

Light receiving sensor 33 detects the light incident through optical filter 32. Light receiving sensor 33 of the present embodiment has a plurality of light receiving elements arranged along two directions.

Light receiving circuit 34 generates a light receiving signal by performing predetermined signal processing (e.g., amplification, frequency filtering, current-voltage conversion, etc.) on the output of light receiving sensor 33. The generated light receiving signal is supplied to distance measurement unit 14 of control unit 1.

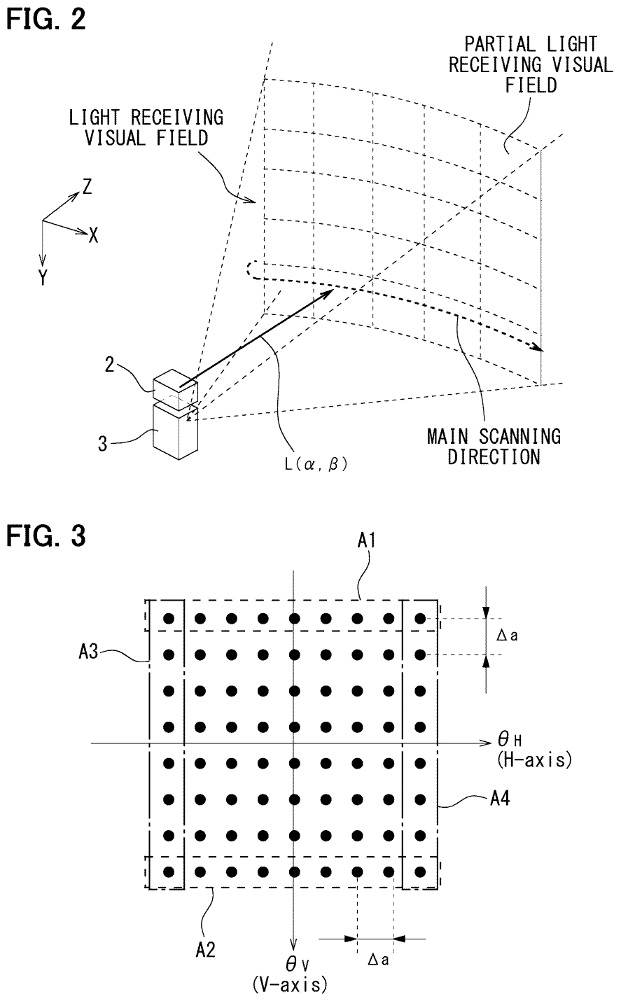

FIG. 2 is a diagram for explaining an example of the arrangement of the light source unit and the light receiving unit, and the light receiving visual field. In this illustrated example, light source unit 2 and light receiving unit 3 are arranged along the Y direction (vertical direction). Emitted light L(α, β) emitted from light source unit 2 is scanned in two dimensions along the X direction and the Y direction. In the present example, the scanning direction along the X direction is defined as the main scanning direction. The entire range light L(α, β) corresponds to the light receiving visual field of light receiving sensor 33. Each area obtained by dividing the light receiving visual field at a predetermined interval in the X direction and the Y direction is defined as a partial light receiving visual field. This partial light receiving visual field may correspond to each of the plurality of light receiving elements included in light receiving sensor 33, or may correspond to a group of several adjacent light receiving elements. Here, note that α and β are variables that represent the rotation angle of MEMS mirror 22, with α corresponding to the main axis rotation angle θ_{H} and β corresponding to the secondary axis rotation angle θ_{V}. The emitted light L(α, β) indicates the emitted light when the main axis rotation angle θ_{H}=α and the secondary axis rotation angle θ_{V}=β.

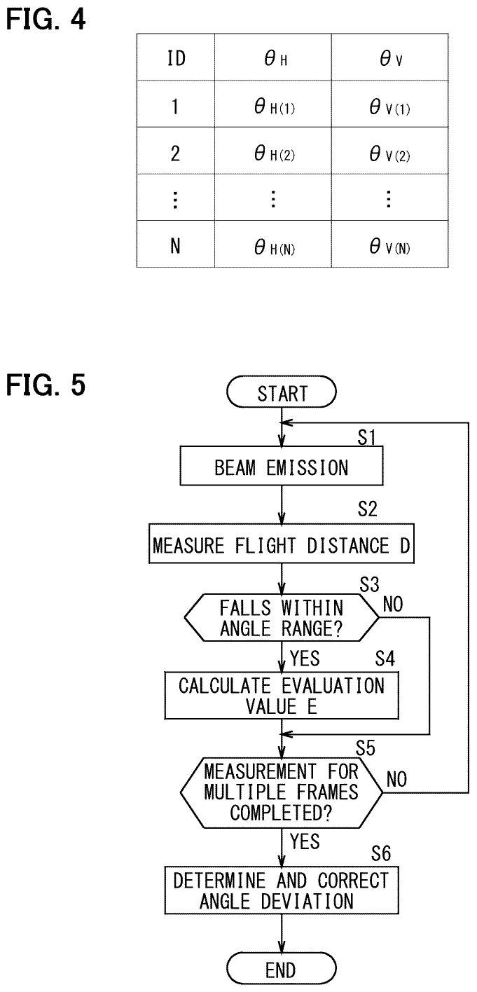

FIG. 3 is a diagram for explaining the predetermined rotation angle of the MEMS mirror. In the figure, the main axis rotation angle θ_{H} of MEMS mirror 22 is plotted along the horizontal axis, and the secondary axis rotation angle θ_{V} is plotted along the vertical axis. Here, in the following description, the horizontal axis may be referred to as the H-axis and the vertical axis may be referred to as the V-axis. A plurality of black dots shown in the figure indicates the positions of the rotation angles on the graph. As shown in the figure, rotation angles are typically set at approximately equal intervals. These rotation angles are set in advance as shown in FIG. 4. For example, the main axis rotation angle θ_{H} which corresponds to rotation angle ID=1 is θ_{H(1)}, and the secondary axis rotation angle θ_{V} which corresponds to rotation angle ID=1 is θ_{V(1)}, and the pair of θ_{H(1)} and θ_{V(1)} corresponds to one of the black dots shown in FIG. 3. The same applies to the main axis rotation angle θ_{H} and secondary axis rotation angle θ_{V} which corresponds to other IDs. Hereinafter, these preset rotation angles may be referred to as “program angles”.

Deflection control unit 12 of control unit 1 controls the deflection angle of MEMS mirror 22 by controlling MEMS driver 21 of light source unit 2 based on the preset main axis rotation angle θ_{H} and secondary axis rotation angle θ_{V}. As a result, emitted light is emitted in a direction determined based on each of the preset main axis rotation angle θ_{H} and secondary axis rotation angle θ_{V}. Then, the reflected light generated by the emitted light is received by light receiving unit 3, and a group of received light signals are processed to obtain the distance to the reflecting object for each partial light receiving visual field.

In the present embodiment, the relationship between the distance obtained for each partial light receiving visual field and the direction of the partial light receiving visual field from which the distance was obtained is compared with a reference corresponding to the above-described preset main axis rotation angle θ_{H} and secondary axis rotation angle θ_{V}, and the deviation in the deflection angle is evaluated. The direction of the partial light receiving visual field is replaced by the two-dimensional positions H_{PD} and V_{PD} of the corresponding light receiving sensor 33. This evaluation is performed for multiple frames and for each of two non-overlapping angle ranges for the main axis and secondary axis respectively (the pair A1, A2 and the pair A3, A4 shown in FIG. 3), and the drive angle of MEMS mirror 22 is corrected according to these results.

As exemplified in FIG. 3, two angle ranges A1 and A2 are symmetrical with respect to the H-axis, and are set to include one row of rotation angles lined up in the H-axis direction at the top and bottom ends of the figure in the V-axis direction. Further, two angle ranges A3 and A4 are symmetrical with respect to the V-axis, and are set to include one row of rotation angles lined up in the V-axis direction at the left and right ends of the figure in the H-axis direction. That is, it is preferable that the pair of A1, A2 and the pair of A3 and A4 are each set approximately symmetrically with respect to the 0 (zero) direction of the H-axis and V-axis (corresponding to the vertical and horizontal axes shown in the figure).

FIG. 5 is a flowchart showing the processing content for detecting deviation in the deflection angle and correcting the drive angle based on the detection results.

Control unit 1 causes light source unit 2 to emit an emission light (beam) based on a preset main axis rotation angle and secondary axis rotation angle (refer to FIG. 4) (step S1). In detail, measurement control unit 11 sends an instruction to deflection control unit 12, which in turn controls MEMS driver 21 to control the drive angle of MEMS mirror 22 to a predetermined main axis rotation angle and secondary axis rotation angle. Then, laser beam from light source 24 is incident on MEMS mirror 22 and reflected, causing the emission light to be emitted from light source unit 2.

Light receiving unit 3 measures the distance (flight distance) D by receiving the reflected light generated by the emitted light (step S2). In detail, the reflected light is incident on light receiving sensor 33 through lens 31 and optical filter 32. Then, a voltage or current according to the intensity of the reflected light is generated at the light receiving unit at any two-dimensional position of light receiving sensor 33, and this voltage or current is processed by light receiving circuit 34 to obtain a light receiving signal. Based on this light receiving signal, distance D is measured by distance measurement unit 14 of control unit 1, and then output to measurement control unit 11.

Next, when flight distance D acquired from distance measurement unit 14 falls within any of the angle ranges A1 to A4 (step S3; YES), measurement control unit 11 calculates an evaluation value E for evaluating the deviation in the deflection angle (step S4). Here, details of the evaluation value E will be described later.

When distance D does not fall within any of angle ranges A1, etc. (step S3; NO), step S4 is omitted and the process proceeds to step S5.

When measurement for the multiple frames has not been completed (step S5; NO), measurement control unit 11 returns to step S1 and repeats the subsequent processes. When measurement for the multiple frames has been completed (step S5; YES), measurement control unit 11 performs the process for determining and correcting the deviation in the deflection angle (step S6). Details of Step S6 will be described later.

Here, instead of having the completion of measurement for the multiple frames to be the completion condition for the series of processes, the completion condition may instead be passage of a predetermined time, or acquisition of a number of samples with distances equal to or greater than a predetermined number for each of angle ranges A1 to A4, or a combination of these may be used as the completion condition.

Here, evaluation value E described above will be explained in detail. As a premise, it is assumed that in step S2 above, the number of reflection points M(i) is obtained for rotation angle condition “i”, and the corresponding flight distance Dᵢ={D_{i, 0}, . . . , D_{i, M(i)}} is obtained, and the two-dimensional position H on the light receiving surface of light receiving sensor 33 where these are detected is set as H_{PD}={H_{PD(0)}, . . . , H_{PD(M(i))}} and V_{PD}={V_{PD(0)}, . . . , V_{PD(M(i))}}.

Evaluation values E(A1) and E(A2) for angle ranges A1 and A2 can be expressed as follows, for example.

$$E ( {A}_{k} ) = {\sum }_{i = 1}^{N} {\sum }_{j = 1}^{M ( i )} ( {V}_{PD ( j )} - {f}_{v} ( {θ}_{H ( i )} , {θ}_{V ( t )} , {D}_{i , j} ) ) / {\sum }_{i = 1}^{N} M ( i ) \qquad ( Equation 1 )$$

Evaluation values E(A3) and E(A4) for angle ranges A3 and A4 can be expressed as follows, for example.

$$E ( {A}_{i} ) = {\sum }_{i = 1}^{N} {\sum }_{j = 1}^{M ( i )} ( {H}_{PD ( j )} - {f}_{h} ( {θ}_{H ( i )} , {θ}_{V ( i )} , {D}_{i , j} ) ) / {\sum }_{i = 1}^{N} M ( i ) \qquad ( Equation 2 )$$

Here, fᵥ is a function showing the reference curve for the rotation angle condition (“distance”−“light receiving position V”), and fₕ is a function showing the reference curve for the rotation angle condition (“distance”−“light receiving position H”).

In detail, function fₕ (θₕ, θᵥ, D) indicates position H_{PD} of light receiving sensor 33 in which light is expected to enter when distance D is obtained for the emitted light (θ_{H}, θ_{V}) when the rotation angles of MEMS mirror 22 are θ_{H} and θ_{V} on the main axis and secondary axis respectively (reference light entrance position). Similarly, function fᵥ(θₕ, θᵥ, D) indicates position V_{PD} of light receiving sensor 33 (reference light entrance position).

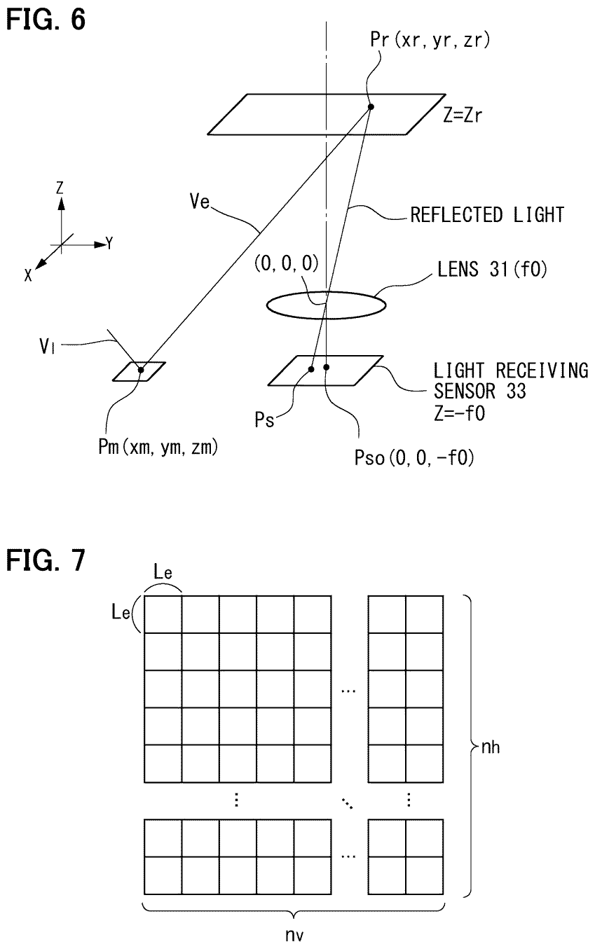

FIG. 6 is a diagram showing the coordinate system of the MEMS mirror, the lens, and the light receiving sensor. Here, it is assumed that the principal point (optical center) of lens 31 with focal length f0 located at the pre-stage of light receiving sensor 33 is set to (0,0,0), and that the central axis of light receiving sensor 33 is parallel to the Z axis and passes through the origin (0,0) of the X and Y axes. Further, the plurality of light receiving elements of light receiving sensor 33 are each square with side length being Le, and nₕ×nᵥ of them are arranged in a row, as exemplified in FIG. 7. Each light receiving element is the smallest unit of light reception.

In FIG. 6, it is assumed that the directional vector of the incident light on MEMS mirror 22 is V_{I}, the deflection point on MEMS mirror 22 is Pm(xm, ym, zm), the directional vector of the emitted light is Vₑ, the Z-axis position of the reflecting surface is Zᵣ, the reflection point of the emitted light on the reflecting surface is Pr(xr, yr, zr), the receiving position of the reflected light at light receiving sensor 33 is Pₛ, the center position of light receiving sensor 33 is Pₛₒ(0, 0, −f0), and the Z-axis position of light receiving sensor 33 is −f0. In the present embodiment, the length of the flight path of the emitted light from deflection point Pm via the reflection point Pr back to light receiving sensor 33 corresponds to the flight distance D.

The direction vector Vₑ(α, β) of the emitted light relative to the program angle (α, β) can be expressed as follows. Here, Nm(α, β) indicates the normal vector of MEMS mirror 22.

$${V}_{e} ( α , β ) = {V}_{l} + 2 ( - {V}_{l} \cdot {N}_{m} ( α , β ) ) \cdot {N}_{m} ( α , β ) \qquad ( Equation 3 )$$

Further, when the emitted light is accurately controlled, the unit vector eₑ(α, β) of the emitted light with respect to the program angle (α, β) can be expressed as follows.

$${e}_{e} ( α , β ) = \frac{{V}_{e} ( α , β )}{\vert {V}_{e} ( α , β ) \vert} = ( {e}_{ex ( α , β )} , {e}_{ey ( a , β )} , {e}_{ez ( α , β )} ) \qquad ( Equation 4 )$$

Further, reflection point Pᵣ can be expressed as follows.

$${P}_{r} = s \cdot {e}_{e} ( α , β ) + {P}_{m} = ( {x}_{r} , {y}_{r} , {z}_{r} ) \qquad ( Equation 5 )$$

Light receiving position Pₛ can be expressed as follows.

$${P}_{s} = - \frac{{f}_{0}}{{z}_{r}} {P}_{r} \qquad ( Equation 6 )$$

The position (H_{PD}, V_{PD}) of light receiving sensor 33 with respect to light receiving position Ps can be expressed as follows.

$$( {H}_{PD} , {V}_{PD} ) = \frac{{f}_{0}}{{z}_{r} \cdot {L}_{e}} ( {x}_{r} , {y}_{r} ) + \frac{1}{2} ( {n}_{h} , {n}_{v} ) \qquad ( Equation 7 )$$

When flight distance is denoted as D, the following relationship is obtained:

$$\begin{matrix}D \approx \vert {P}_{r} - {P}_{m} \vert + \vert {P}_{s} - {P}_{r} \vert \\ = s + \frac{{z}_{r} + {f}_{0}}{{z}_{r}} \vert {P}_{r} \vert \\ \approx s ( 2 + \frac{{f}_{0}}{{z}_{r}} ) = s ( 2 + \frac{{f}_{0}}{s \cdot {e}_{ez ( α , β )}} ) \\ = 2 s + \frac{{f}_{0}}{{e}_{ez ( α , β )}}\end{matrix} \qquad ( Equation 8 )$$

$$s \approx \frac{1}{2} ( D - \frac{{f}_{0}}{{e}_{ez ( α , β )}} )$$

When flight distance D for the emitted light is obtained, functions fₕ and fᵥ can be expressed as follows. Here, note that the following relational expression is an approximation equation which assumes that the distance between the deflection point Pm and the principal point of lens 31 is very small compared to flight distance D.

$${f}_{h} ( α , β , D ) = \frac{{f}_{0}}{{L}_{e}} \frac{s \cdot {e}_{ex ( α , β )} + {x}_{m}}{s \cdot {e}_{ez ( α , β )} + {z}_{m}} + \frac{1}{2} {n}_{h} \qquad ( Equation 9 )$$

$${f}_{v} ( α , β , D ) = \frac{{f}_{0}}{{L}_{e}} \frac{s \cdot {e}_{ey ( α , β )} + {y}_{m}}{s \cdot {e}_{ez ( α , β )} + {z}_{m}} + \frac{1}{2} {n}_{v}$$

$$s = \frac{1}{2} ( D - \frac{{f}_{0}}{{e}_{ez ( α , β )}} )$$

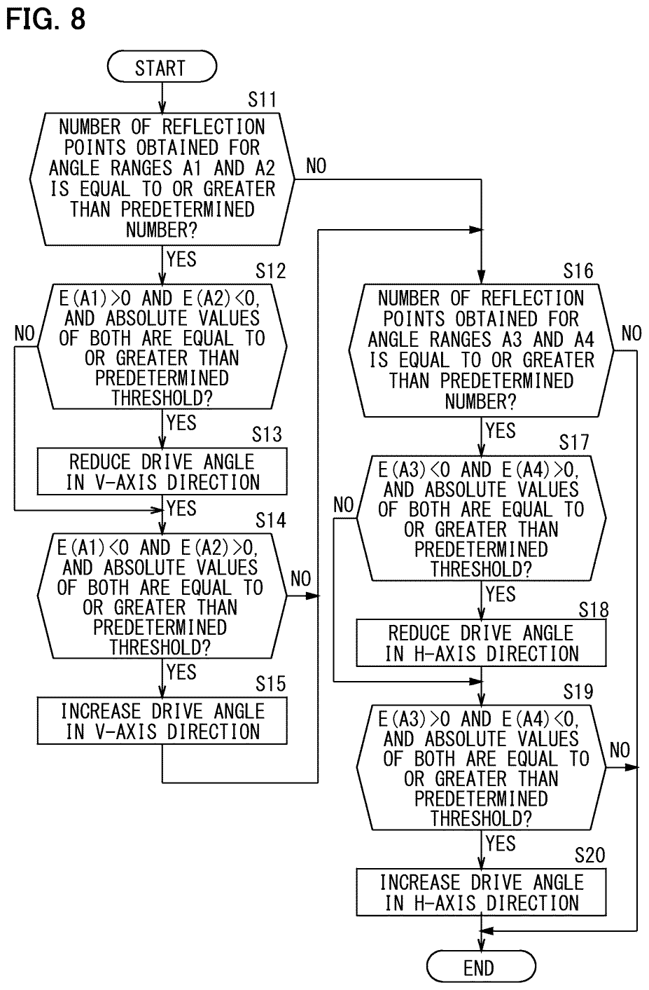

FIG. 8 is a flowchart for explaining the detailed processing content of step S6 in FIG. 5 described above. Here, using the above content as an example of evaluation value E, the following describes a method for determining the deviation in the deflection angle and correcting the deviation.

When the number of reflection points obtained for angle ranges A1 and A2 is equal to or greater than a predetermined number (step S11; YES), measurement control unit 11 calculates evaluation values E(A1) and E(A2) for A1 and A2, respectively, and when E(A1)>0, E(A2)<0, and the absolute values of both are equal to or greater than a predetermined threshold value (step S12; YES), the drive angle of MEMS mirror 22 in the V-axis direction is reduced (step S13). On the other hand, when the judging criteria in step S12 are not met (step S12; NO), step S13 is omitted and the program proceeds to step S14.

Here, reducing the drive angle means reducing the angle range when MEMS mirror 22 is periodically operated in the V-axis direction. It is assumed that a fixed amount of minute angle is increased or reduced, but it is also possible to determine a coefficient based on the evaluation value and multiply a fixed value by this coefficient.

Further, the threshold values for each of evaluation values E(A1) and E(A2) are determined in accordance with the specified maximum allowable error of the light emission direction (angle). For example, they may be determined by actually measuring the change in the position of the light receiving surface of light receiving sensor 33 during device calibration, or they may be determined by estimating using the relational expression shown in Equation 9 described above.

In the former case, for example, in a state where the light emission direction is calibrated to become an ideal state, and in a state where the light emission direction is calibrated to deviate by maximum allowable error amount from the ideal state, a group of light receiving positions V_{PD} for the light emission in angle ranges A1 and A2 can be obtained, and the amount of change (average value) of the group of light receiving positions V_{PD} obtained in these two states can be used as a threshold value.

In the latter case, for example, function fᵥ can be calculated for the representative direction within angle ranges A1 and A2, i.e., the central direction of each range (θ_{sample_h}, θ_{sample_v}), and for the direction deviated from there by error amount θ_{Verr} of the secondary axis rotation angle corresponding to the maximum allowable error in the light emission direction (angle), and the difference between them can be used as a threshold value. That is, it can be expressed as follows. Here, note that Dₛₐₘₚₗₑ is a value that falls within the range of a flight distance that can be measured by the apparatus, and can be set to the distance value of the midpoint of that range, for example.

$$Threshold value = \vert {f}_{h} ( {θ}_{sam ple \_ h} , {θ}_{sam ple \_ v} , {D}_{sample} ) - {f}_{h} ( {θ}_{sam ple \_ h} + {θ}_{Herrr} , {θ}_{sam ple \_ v} , {D}_{sample} ) \vert$$

When evaluation values E(A1) and E(A2) for angle ranges A1 and A2 are E(A1)<0, E(A2)>0, and the absolute values of both are equal to or greater than a predetermined threshold value (step S14; YES), measurement control unit 11 increases the drive angle of MEMS mirror 22 in the V-axis direction (step S15). On the other hand, when the judging criteria in step S14 are not met (step S14; NO), step S15 is omitted and the process proceeds to step S16.

Here, increasing the drive angle means increasing the angle range when MEMS mirror 22 is periodically operated in the V-axis direction. It is assumed that a fixed amount of minute angle is increased or reduced, but it is also possible to determine a coefficient based on the evaluation value and multiply a fixed value by this coefficient.

When the number of reflection points obtained in step S11 is not equal to or greater than the predetermined number (step S11; NO), or when the conditions in step S14 that E(A1)<0, E(A2)>0 and the absolute values of both being equal to or greater than the predetermined threshold value are not met (step S14; NO), or when the processing of step S15 has been performed, measurement control unit 11 proceeds to step S16.

When the number of reflection points obtained for angle ranges A3 and A4 is equal to or greater than a predetermined number (step S16; YES), measurement control unit 11 calculates evaluation values E(A3) and E(A4) for A3 and A4, respectively, and when E(A3)<0, E(A4)>0 and the absolute values of both are equal to or greater than a predetermined threshold value (step S17; YES), the drive angle of MEMS mirror 22 in the H-axis direction is reduced (step S18). On the other hand, when the judging criteria in step S17 are not met (step S17; NO), step S18 is omitted and the process proceeds to step S19.

Here, reducing the drive angle means reducing the angle range when MEMS mirror 22 is periodically operated in the H-axis direction. It is assumed that a fixed amount of minute angle is increased or reduced, but it is also possible to determine a coefficient based on the evaluation value and multiply a fixed value by this coefficient.

Further, in the same manner as evaluation values E(A1) and E(A2) described above, the threshold value for each of evaluation values E(A3) and E(A4) are determined in accordance with the specified maximum allowable error of the light emission direction (angle). For example, they may be determined by actually measuring the change in the position of the light receiving surface of light receiving sensor 33 during device calibration, or they may be determined by estimating using the relational expression shown in Equation 9 described above.

In the former case, for example, in a state where the light emission direction is calibrated to become an ideal state, and in a state where the light emission direction is calibrated to deviate by maximum allowable error amount from the ideal state, a group of light receiving positions H_{PD} for the light emission in angle ranges A3 and A4 can be obtained, and the amount of change (average value) of the group of light receiving positions H_{PD} obtained in these two states can be used as a threshold value.

In the latter case, for example, function fₕ can be calculated for the representative direction within angle ranges A3 and A4, i.e., the central direction of each range (θ_{sample_h}, θ_{sample_v}), and for the direction deviated from there by the error amount θ_{Herr} of the secondary axis rotation angle corresponding to the maximum allowable error in the light emission direction (angle), and the difference between the two can be used as a threshold value. That is, it can be expressed as follows. Here, note that Dₛₐₘₚₗₑ is a value that falls within the range of flight distance that can be measured by the apparatus, and can be set to a distance value of the midpoint of that range, for example.

$$Threshold value = \vert {f}_{h} ( {θ}_{sam ple \_ h} , {θ}_{sam ple \_ v} , {D}_{sample} ) - {f}_{h} ( {θ}_{sam ple \_ h} + {θ}_{Herrr} , {θ}_{sam ple \_ v} , {D}_{sample} ) \vert$$

When evaluation values E(A3) and E(A4) for angle ranges A3 and A4 are E(A3)>0 and E(A4)<0, and the absolute values of both are equal to or greater than a predetermined threshold value (step S19; YES), measurement control unit 11 increases the drive angle of MEMS mirror 22 in the H-axis direction (step S20). On the other hand, when the judging criteria in step S19 are not met (step S19; NO), step S20 is omitted.

Here, increasing the drive angle means increasing the angle range when MEMS mirror 22 is periodically operated in the H-axis direction. It is assumed that a fixed amount of minute angle is increased or reduced, but it is also possible to determine a coefficient based on the evaluation value and multiply a fixed value by this coefficient.

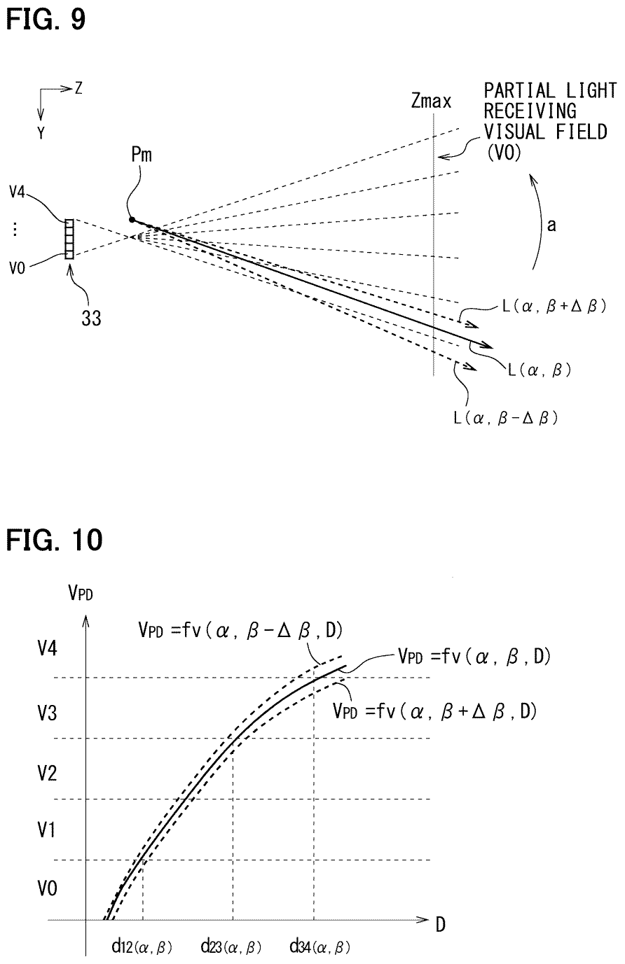

FIG. 9 is a schematic diagram showing the flight path of the emitted light in an ideal state and the flight path of the emitted light when the rotation angle is deviated in the V-axis direction. FIG. 9 shows the flight path of the emitted light from the deflection point Pm on MEMS mirror 22 to the reflecting object in YZ plane. Here, for simplicity of explanation, the positions of the light receiving units of light receiving sensor 33 are denoted as V0 to V4, and partial light receiving visual fields corresponding to these units are formed. Further, arrow “a” indicates direction of beam deflection due to positive rotation of MEMS mirror 22 in the V-axis direction. Zmax indicates the position of the reflecting object in the Z-axis direction (for example, a reflector installed in advance for calibration purpose).

As shown in FIG. 9, the flight path of the emitted light in an ideal state, that is, when the rotation angle of MEMS mirror 22 in the V-axis direction is controlled as expected (assumed), is defined as L(α, β) (shown in a solid line). Further, the flight path of the emitted light when the rotation angle in the V-axis direction is deviated by-AB is defined as L(α, β−Δβ) (shown in a dotted line). Furthermore, the flight path of the emitted light when the rotation angle in the V-axis direction is deviated by +Δβ is defined as L(α, β+Δβ) (shown in a dotted line).

FIG. 10 is a diagram showing the relationship between flight distance D of the flight path of the emitted light illustrated in FIG. 9 and the position of the light receiving sensor that receives the reflected light. The vertical axis represents the positions V0 to V4 of the light receiving unit of light receiving sensor 33, and the horizontal axis represents flight distance D. f_{V}(α, β, D) is a reference curve that can be acquired when the number of reflections is 1. f_{V}(α, β−Δβ, D) and f_{V}(α, β+Δβ, D) are curves for fluctuation of ±Δβ, respectively.

When the rotation angle in the V-axis direction is deviated by −Δβ, since the deflection angle is increased more than the ideal state, in order to reduce the range of the deflection angle, the drive angle in the V-axis direction of MEMS mirror 22 is reduced by, for example, AB in absolute value. On the other hand, when the rotation angle in the V-axis direction is deviated by +Δβ, since the deflection angle is reduced more than the ideal state, in order to increase the range of the deflection angle, the drive angle in the V-axis direction of MEMS mirror 22 is increased by, for example, Δβ in absolute value. The drive angle here is defined as the range of angles that can be obtained when MEMS mirror 22 is rotated periodically. Further, the rotation angle here is defined as one rotational state of MEMS mirror 22 in periodic rotational motion, i.e., the rotation state seen at a certain timing.

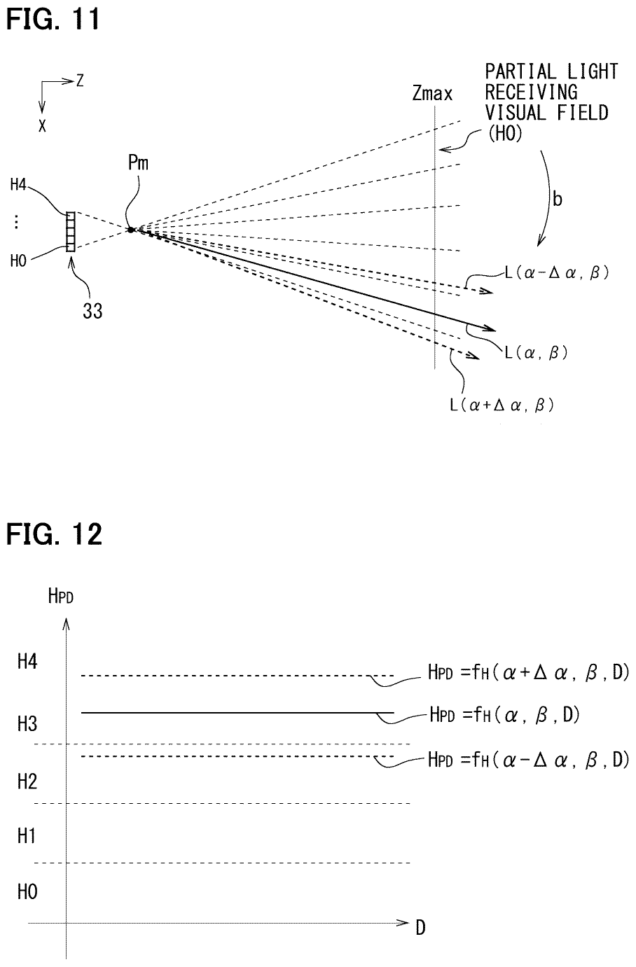

FIG. 11 is a schematic diagram showing the flight path of the emitted light in an ideal state and the flight path of the emitted light when the rotation angle is deviated in the H-axis direction. FIG. 11 shows the flight path of the emitted light from the deflection point Pm on MEMS mirror 22 to the reflector, in XZ plane. Here too, for simplicity of explanation, the positions of the light receiving units of light receiving sensor 33 are denoted as H0 to H4, and partial light receiving visual fields corresponding to these units are formed. Further, arrow “b” indicates direction of beam deflection due to the positive rotation of MEMS mirror 22 in the H-axis direction. Zmax indicates the position of the reflecting object in the Z-axis direction (for example, a reflector installed in advance for calibration purpose).

FIG. 12 is a diagram showing the relationship between the flight distance D of the flight path of the emitted light illustrated in FIG. 11 and the position of the light receiving sensor that receives the reflected light. The vertical axis represents the positions H0 to H4 of the light receiving unit of light receiving sensor 33, and the horizontal axis represents flight distance D. f_{H}(α, β, D) is a reference curve that can be acquired when the number of reflections is 1. f_{H}(α−Δα, β, D) and f_{H}(α+Δα, β, D) are curves for fluctuation of ±Δα, respectively.

As shown in FIG. 11, the flight path of the emitted light in an ideal state, that is, when the rotation angle of mirror 22 in the H-axis direction is controlled as MEMS expected (assumed), is defined as L(α, β) (shown in a solid line). Further, the flight path of the emitted light when the rotation angle in the H-axis direction is deviated by −Δα is defined as L(α−Δα, β) (shown in a dotted line). Furthermore, the flight path of the emitted light when the rotation angle in the H-axis direction is deviated by +Δα is defined as L(α+Δα, β) (shown in a dotted line).

When the rotation angle in the H-axis direction is deviated by −Δα, since the deflection angle is reduced more than the ideal state, in order to increase the range of the deflection angle, the drive angle in the H-axis direction of MEMS mirror 22 is increased by Δα in absolute value, for example. On the other hand, when the rotation angle in the H-axis direction is deviated by +Δα, since the deflection angle is increased more than the ideal state, in order to reduce the range of the deflection angle, the drive angle in the H-axis direction of MEMS mirror 22 is reduced by Δα in absolute value, for example.

According to the first embodiment described above, in a distance measurement apparatus using a laser beam, it is possible to suppress a decrease in distance measurement performance with a simple configuration and to maintain an appropriate distance measurement range.

Specifically, by using the angular resolution in which each light receiving unit on the light receiving surface of light receiving sensor 33 is the smallest unit, and by using flight distance of the assumed flight path of the emitted light and its position on the light receiving surface of light receiving sensor 33 at that time as a reference, and further, by comparing the reference with the actually measured flight distance and its position on the light receiving surface at that time, it is possible to detect presence or absence of deviation of deflection and the direction of deviation of deflection, and to correct (calibrate) deviation of deflection. In this case, since it is not necessary to dispose a plurality of markers or the like on the flight path of the emitted light, no blind spots or directions with poor distance measurement performance are created, therefore no decrease in distance measurement performance is caused.

Further, since deviation of angle is grasped for each of the main axis and secondary axis in two angle ranges that do not overlap in the axial direction, they can be detected even when the drive angle of MEMS mirror 22 is increased or reduced due to the usage environment or deterioration over time. Further, by correcting the drive angle of MEMS mirror 22 in accordance with the detection results, it is possible to suppress deviations in the light emission direction. Furthermore, since it is possible to prevent light from being emitted in a direction outside the partial light receiving visual field of interest, it is possible to suppress a decrease in measurement performance when applied to a system that aims for a high S/N ratio by receiving light only in the direction corresponding to the light emission direction, for example.

### Second embodiment

In the distance measurement apparatus of the first embodiment described above, a part of angle range A1 to A4 may be set to an angle that falls outside the measurement range in normal distance measurement operation, and a fixed mirror may be provided to a post-stage of MEMS mirror 22 so that the emitted light reflected in angle range A1 to A4 is deflected in a direction that crosses the light receiving visual field of light receiving sensor 33. Hereinafter, description of common configurations between the above-described second embodiment and the first embodiment will be omitted, and the difference will be explained in detail.

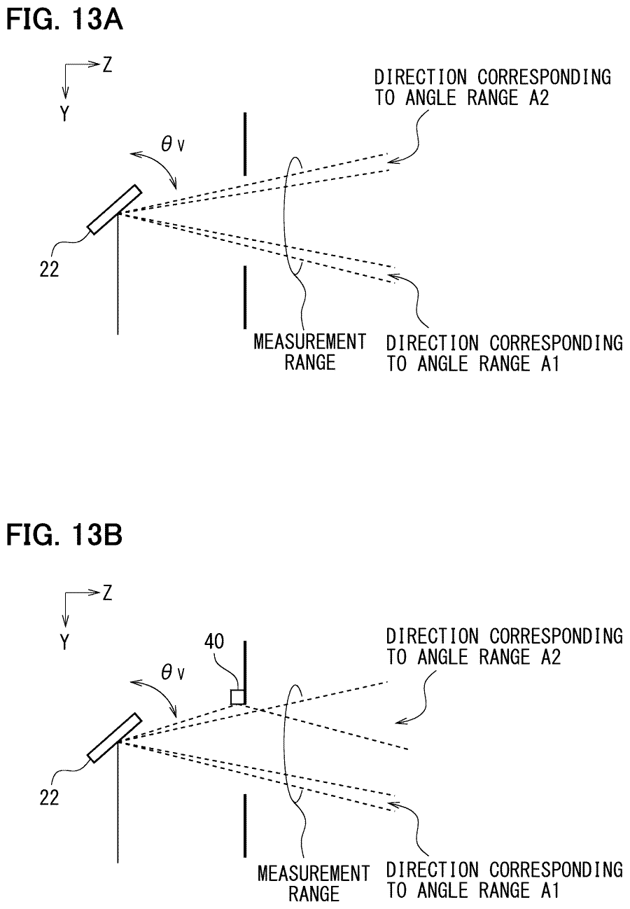

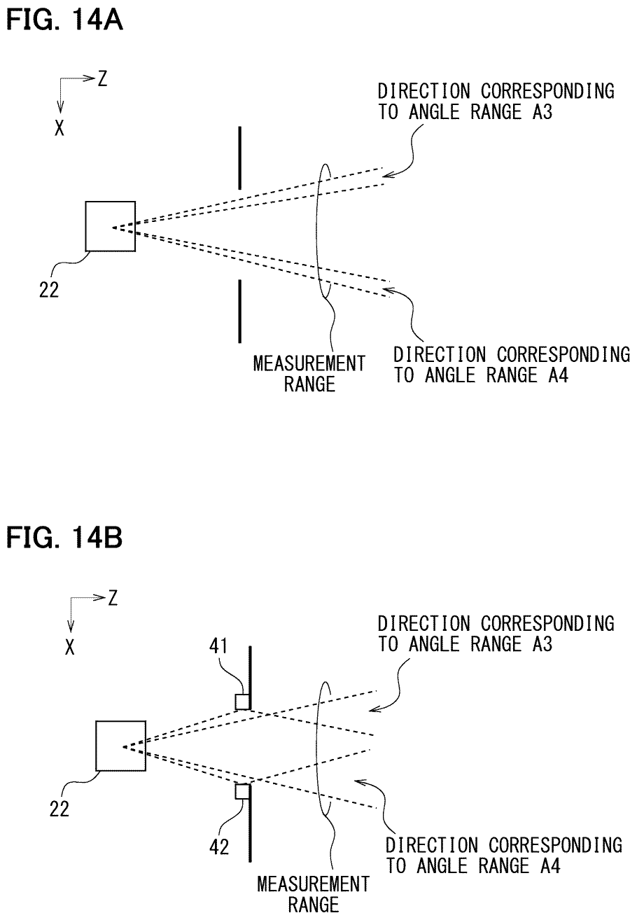

In the first embodiment, as shown in FIGS. 13A and 14A, the emitted light reflected by MEMS mirror 22 is emitted as it is in the direction corresponding to angle ranges A1 to A4, respectively. In contrast, in the second embodiment, as shown in FIG. 13B, for example, part of angle range A2 is set to an angle that falls outside the measurement range, and the emitted light emitted at this angle is deflected in a direction crossing the light receiving visual field (within the measurement range) by folding back the emitted light by the fixed mirror 40. Similarly, as shown in FIG. 14B, part of each of angle ranges A3 and A4 are set to an angle that falls outside the measurement range, and the emitted lights emitted at these angle are deflected in a direction crossing the light receiving visual field (within the measurement range) by folding back the emitted lights by the fixed mirrors 41 and 42. By doing so, the change in the light receiving position at light receiving sensor 33 when a deviation in the deflection angle occurs can be made greater, thereby making it easier to detect the deviation.

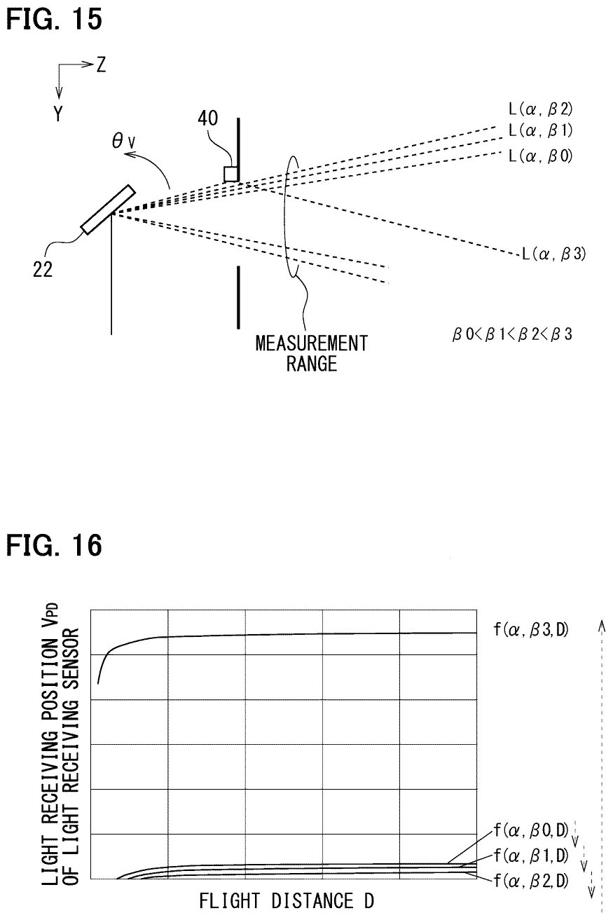

Further, it is also possible to detect deviation in the deflection angle by examining the conditions under which the direction of shift of the distance-light receiving position curve is reversed with respect to monotonous changes in the angular condition θ_{H} or θ_{V} of the emitted light. As shown in FIG. 15, the emitted light reflected by MEMS mirror 22 transitions from L(α, β0) to L(α, β1) to L(α, β2) toward the end of the measurement range as θ_{V} increases, but when it reaches the deflection angle at which it is reflected by the fixed mirror 40, it becomes the emitted light L(α, β3) deflected in a direction that crosses the measurement range. Here, note that β0<β1<β2<β3. In this case, the relationship between flight distance D and light receiving position V_{PD} of light receiving sensor 33 is as illustrated in FIG. 16, where the light receiving position V_{PD} transitions toward a smaller value, but when it transitions to the point where it follows the flight path via the fixed mirror 40 (in this example, when the secondary axis rotation angle is β3), light receiving position V_{PD} conversely transitions to a larger value. By comparing this with the reference, it is possible to detect the presence or absence of deviation of the angle and the amount of deviation.

In the second embodiment described above, as with the first embodiment, in a distance measurement apparatus using a laser beam, it is possible to suppress a decrease in distance measurement performance with a simple configuration and to maintain an appropriate distance measurement range.

### Third Embodiment

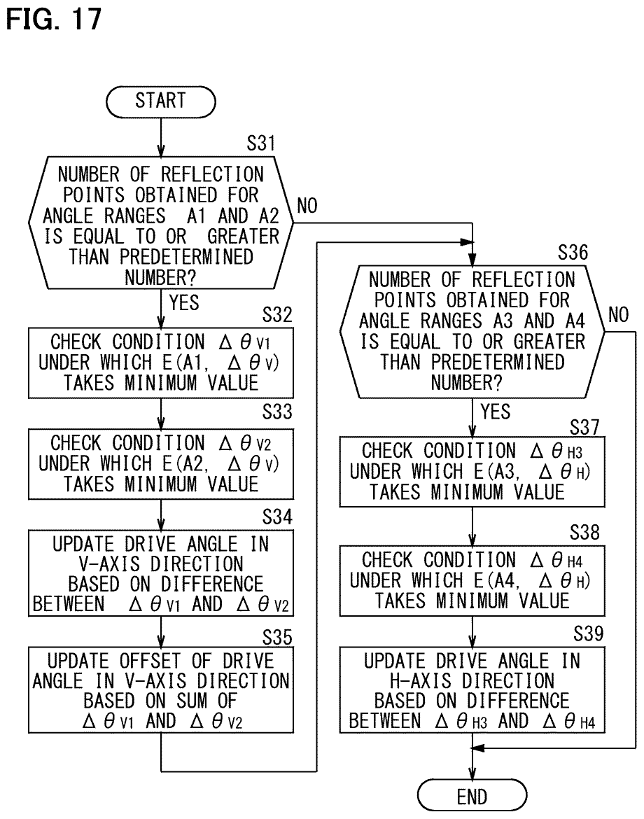

The distance measurement apparatus of the third embodiment has the same device configuration as the distance measurement apparatus of the first embodiment, but differs in the processing content of step S6 in FIG. 5 described above. Hereinafter, description of common configuration between the two embodiments will be omitted, and the processing content of step S6, which is the difference, will be described in detail with reference to FIG. 17.

When the number of reflection points obtained for angle ranges A1 and A2 is equal to or greater than a predetermined number (step S31; YES), measurement control unit 11 checks the condition Δθ_{V1} under which evaluation value E(A1, Δθ_{V}) for A1 takes the minimum value (step S32). Further, measurement control unit 11 checks the condition Δθ_{V2} under which evaluation value E(A2, Δθ_{V}) for A2 takes the minimum value (step S33).

Here, evaluation values E for A1 and A2 in the third embodiment can be obtained, for example, using the evaluation formula shown below. Here, note that −a≤θ_{V}≤a. “±a” uses a value smaller than the drive angle in the V-axis direction. More specifically, “±a” indicates the amount of change in the angle that can occur due to the usage environment (temperature, air pressure, etc.), deterioration over time, etc.

$$( Equation 10 )$$

$$E ( {A}_{k} , {Δθ}_{V} ) = {\sum }_{i = 1}^{N} {\sum }_{j = 1}^{M ( i )} ( {V}_{PD ( j )} - {f}_{v} ( {θ}_{H ( i )} + Δ {θ}_{H} , {θ}_{V ( i )} , {D}_{i , j} ) ) w ( {D}_{i , j} ) / {\sum }_{i = 1}^{N} M ( i )$$

In the above evaluation formula, w(D_{i,j}) is a weighting coefficient that is set to suppress the effects of points with poor light receiving conditions (for example, the effects of points being close to the light receiving sensor, or distant points where the amount of light received is extremely low and no light reception is expected). For example, it can be set as follows. Note that D_{N} and D_{f} are used to limit the distance range in which the evaluation is valid.

$${w}_{v} ( D ) = \{ \begin{matrix}1 & ( {D}_{n} \leq D \leq {D}_{f} ) \\ 0 & ( Other than the above D )\end{matrix} \qquad ( Equation 11 )$$

The conditions under which evaluation values E for A1 and A2 become minimum will be described. For the parameter Δθᵥ in the relational expression shown in Equation 10, multiple conditions {Δθ_{A1V0}, Δθ_{A1V1}, . . . } are set so that the numerical range is within a certain numerical range (−a≤θ_{V}≤a) at intervals smaller than the control allowable error, and evaluation values E(A1, Δθ_{V0}), E(A1, Δθ_{V1}), . . . are calculated by applying them in order. Then, the condition that results in the smallest evaluation value E among the multiple conditions {Δθ_{A1V0}, Δθ_{A1V1}, . . . } is extracted. Further, the condition under which evaluation value E(A2, Δθ_{V}) becomes minimum can be extracted in a similar manner as well.

Next, measurement control unit 11 updates the drive angle in the V-axis direction based on the difference between Δθ_{V1} and Δθ_{V2} (step S34). Specifically, it instructs deflection control unit 12 to subtract the difference between Δθ_{V1} and Δθ_{V2}, that is, (Δθ_{V2}−Δθ_{V1}) degrees from the current drive angle.

Next, measurement control unit 11 updates the offset of the drive angle in the V-axis direction based on the sum of Δθ_{V1} and Δθ_{V2} (step S35). Specifically, it instructs deflection control unit 12 to subtract {(Δθ_{V2}+Δθ_{V1})/2} degrees from the current value of the angle which is the central direction angle θ_{vc} of the drive.

The above-stated central direction angle Ove of the drive will now be described. When the drive angle range in the V-axis direction is θᵥₘᵢₙ≤θᵥ≤θᵥₘₐₓ, the central direction angle θ_{vc} can be expressed as θ_{vc}==(θᵥₘᵢₙ+θᵥₘₐₓ)/2. Further, when the drive angle updated in step S34 is defined as θᵥₐₘₚ, its magnitude can be expressed as θᵥₐₘₚ=θᵥₘₐₓ−θᵥₘᵢₙ.

Here, when the judging criteria in step S31 are not met (step S31; NO), steps S32 to S35 are omitted and the process proceeds to step S36.

When the number of acquired reflection points for angle ranges A3 and A4 is equal to or greater than a predetermined number (step S36; YES), measurement control unit 11 checks the condition Δθ_{H3} under which evaluation value E(A3, Δθ_{H}) for A3 takes the minimum value (step S37). Further, measurement control unit 11 also checks the condition Δθ_{H4} under which evaluation value E(A4, Δθ_{H}) for A4 takes the minimum value (step S38).

Here, evaluation value E for A3 and A4 in the third embodiment can be obtained, for example, using the evaluation formula shown below. Note that −a≤θ_{H}≤a. “±a” uses a value smaller than the drive angle in the H-axis direction. More specifically, “±a” indicates the amount of change in the angle that can occur due to the usage environment (temperature, air pressure, etc.) and deterioration over time. “±a” may be a different value from that of the V-axis direction described above.

$$( Equation 12 )$$

$$E ( {A}_{i} , {Δθ}_{H} ) = {\sum }_{i = 1}^{N} {\sum }_{j = 1}^{M ( i )} ( {H}_{PD ( j )} - {f}_{h} ( {θ}_{H ( i )} + Δ {θ}_{H} , {θ}_{V ( i )} , {D}_{i , j} ) ) w ( {D}_{i , j} ) / {\sum }_{i = 1}^{N} M ( i )$$

In the above evaluation formula, w(D_{i,j}) is a weighting coefficient, which is set so as to suppress the influence of points where the light receiving conditions are poor (for example, the influence of points close to the light receiving sensor, or distant points where the amount of light received is extremely low and no light reception is expected). For example, it can be set as follows.

$${w}_{h} ( D ) = \{ \begin{matrix}1 & ( {D}_{n} \leq D \leq {D}_{f} ) \\ 0 & ( Other than the above D )\end{matrix} \qquad ( Equation 13 )$$

Next, measurement control unit 11 updates the drive angle in the H-axis direction based on the difference between Δθ_{H3} and Δθ_{H4} (step S39). Specifically, it instructs deflection control unit 12 to subtract the difference between Δθ_{H3} and Δθ_{H4}, that is, (Δθ_{H4}−Δθ_{H3}) degrees from the current drive angle.

In the third embodiment described above, as with the first embodiment, in a distance measurement apparatus using a laser beam, it is possible to suppress a decrease in distance measurement performance with a simple configuration and to maintain an appropriate distance measurement range.

### Fourth Embodiment

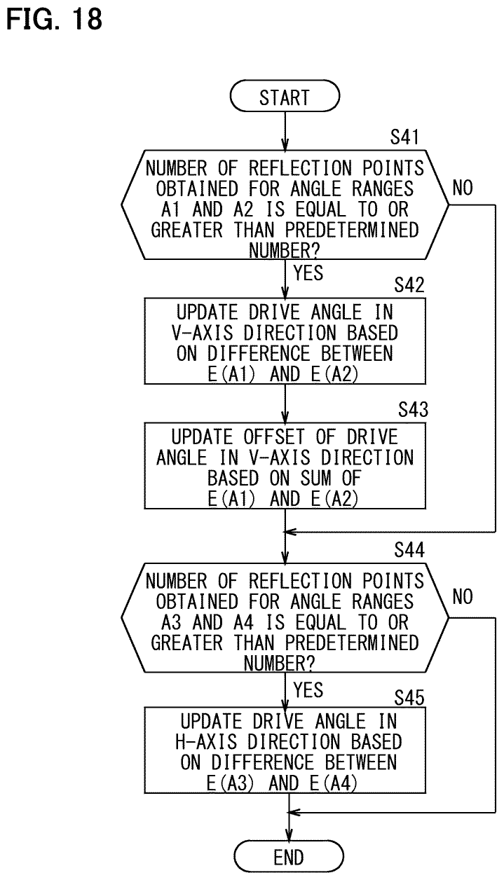

The distance measurement apparatus of the fourth embodiment has the same device configuration as the distance measurement apparatus of the first embodiment, but differs in the processing content of step S6 in FIG. 5 described above. Hereinafter, description of common configuration will be omitted, and the processing content of step S6, which is the difference, will be described in detail with reference to FIG. 18.

When the number of acquired reflection points for angle ranges A1 and A2 is equal to or greater than a predetermined number (step S41; YES), measurement control unit 11 updates the drive angle in the V-axis direction based on the difference between evaluation value E(A1) for A1 and evaluation value E(A2) for A2 (step S42). Specifically, it instructs deflection control unit 12 to change the current drive angle by g(E(A2)−E(A1)) degrees. Here, note that “g” is a gain coefficient (0<g<1).

Here, evaluation value E for A1 and A2 in the fourth embodiment can be obtained, for example, using the evaluation formula shown below.

$$( Equation 14 )$$

$$B ( {A}_{k} ) = {\sum }_{i = 1}^{N} {\sum }_{j = 1}^{M ( i )} ( {V}_{PD ( j )} - {f}_{ν} ( {θ}_{H ( i )} , {θ}_{V ( i )} , {D}_{i , j} ) ) {w}_{ν} ( {θ}_{H ( i )} , {θ}_{V ( i )} , {D}_{i , j} ) / {\sum }_{i = 1}^{N} M ( i )$$

In the above evaluation formula, fᵥ is shown in Equation 9 described above. Further, wᵥ(θ_{H(i)}, θ_{V(i)}, D_{i,j}) is a weighting coefficient, which is set to suppress the influence of points where the light receiving conditions are poor (for example, the influence of points close to the light receiving sensor, or distant points where the amount of received light is extremely low and no light can be expected). In detail, the weighting coefficient is set so that evaluation formula E returns approximately the same value for the same amount of angular deviation regardless of the angle parameters θ_{H(i)}, θ_{V(i)}.

Further, wᵥ(θ_{H(i)}, θ_{V(i)}, D_{i,j}) can be set as follows, for example. Here, “Δa” is the angle interval of the program angle group (refer to FIG. 3). D_{N} and D_{f} are used to exclude points with poor light receiving conditions.

$$( Equation 15 )$$

$${w}_{v} ( {θ}_{H} , {θ}_{V} , D ) = \{ \begin{matrix}\frac{( 2 Δ a )}{\begin{matrix}{f}_{v} ( {θ}_{H} , {θ}_{V} + Δ a , D ) - \\ {f}_{v} ( {θ}_{H} , {θ}_{V} - Δ a , D )\end{matrix}} & ( {D}_{n} \leq D \leq {D}_{f} ) \\ 0 & ( Other than the above D )\end{matrix}$$

Further, measurement control unit 11 updates the offset of the drive angle in the V-axis direction based on the sum of E(A1) and E(A2) (step S43). Specifically, it instructs deflection control unit 12 to subtract g{(E(A2)+E(A1))/2} degrees from the current value of the angle that becomes the central direction angle of the drive. Here, note that “g” is a gain coefficient (0<g<1). Further, the central direction angle of the drive θ_{vc} is defined as above, and can be expressed as θ_{vc}=(θᵥₘᵢₙ+θᵥₘₐₓ)/2. Furthermore, when the drive angle updated in step S42 is defined as θᵥₐₘₚ, its magnitude can be expressed as θᵥₐₘₚ=θᵥₘₐₓ−θᵥₘᵢₙ.

Here, when the judging criteria in step S41 are not met (step S41; NO), steps S42 and S43 are omitted and the process proceeds to step S44.

When the number of acquired reflection points for angle ranges A3 and A4 is equal to or greater than a predetermined number (step S44; YES), measurement control unit 11 updates the drive angle in the H-axis direction based on the difference between the evaluation value E(A3) for A3 and the evaluation value E(A4) for A4 (step S45). Specifically, it instructs deflection control unit 12 to subtract h(E(A4)−E(A3)) degrees from the current drive angle. Here, note that “h” is a gain coefficient (0<h<1).

Here, evaluation values E for A3 and A4 in the fourth embodiment can be obtained using the evaluation formula shown below, for example.

$$( Equation 16 )$$

$$E ( {A}_{i} ) = {\sum }_{i = 1}^{N} {\sum }_{j = 1}^{M ( i )} ( {H}_{PD ( j )} - {f}_{h} ( {θ}_{H ( i )} , {θ}_{V ( i )} , {D}_{i , j} ) ) {w}_{h} ( {θ}_{H ( i )} , {θ}_{V ( i )} , {D}_{i , j} ) / {\sum }_{i = 1}^{N} M ( i )$$

In the above evaluation formula, fₕ is shown in Equation 9 described above. Further, wₕ(θ_{H(i)}, θ_{V(i)}, D_{i,j}) is a weighting coefficient, which is set so as to suppress the influence of points where the light receiving conditions are poor (for example, the influence of points close to the light receiving sensor, or distant points where the amount of light received is extremely low and no light reception is expected). In detail, the weighting coefficient is set so as to correct evaluation formula E so that it returns approximately the same value for the same amount of angular deviation regardless of the angle parameters θ_{H(i)}, θ_{V(i)}. For example, it can be set as follows. Here, “Δa” is the angle interval of the program angle group (refer to FIG. 3).

$$( Equation 17 )$$

$${w}_{h} ( {θ}_{H} , {θ}_{V} , D ) = \{ \begin{matrix}\frac{( 2 Δ a )}{\begin{matrix}{f}_{h} ( {θ}_{H} + Δ a , {θ}_{V} , D ) - \\ {f}_{h} ( {θ}_{H} - Δ a , {θ}_{V} , D )\end{matrix}} & ( {D}_{n} \leq D \leq {D}_{f} ) \\ 0 & ( Other than the above D )\end{matrix}$$

In the fourth embodiment described above, as with the first embodiment, in a distance measurement apparatus using a laser beam, it is possible to suppress a decrease in distance measurement performance with a simple configuration and to maintain an appropriate distance measurement range.

Here, note that the present disclosure is not limited to the content of the above described embodiments, and various modifications can be made within the scope of the gist of the present disclosure.

The present application is based on, and claims priority from, JP Application Serial Number, 2024-077445 filed on May 10, 2024, the disclosure of which is hereby incorporated by reference herein in its entirety.

### DESCRIPTION OF SYMBOLS

1: Control unit
2: Light source unit
3: Light receiving unit
11: Measurement control unit
12: Deflection control unit
13: Lighting control unit
14: Distance measurement unit
15: Communication unit
21: MEMS driver
22: MEMS mirror
23: Light source driver
24: Light source
31: Lens
32: Optical filter
33: Light receiving sensor
34: Light receiving circuit

What is claimed is:

1. A distance measurement apparatus for measuring a distance between the apparatus and an object comprising:
a light source that emits a laser beam;
a deflector that deflects the laser beam emitted from the light source;
a light receiving sensor that receives a reflected light generated when the laser beam deflected by the deflector is irradiated onto the object; and
a controller that controls the operation of the light source and the deflector and measures the distance between the object based on the reflected light received by the light receiving sensor,
wherein the controller detects a control deviation of the deflector based on a difference between a reference light entrance position of the laser beam on the light receiving surface of the light receiving sensor that is assumed for a rotation angle being set in the deflector and an actual light entrance position of the laser beam at the light receiving sensor that is determined based on the reflected light generated by actually operating the deflector at the rotation angle being set to deflect the laser beam.

2. The distance measurement apparatus according to claim 1,
wherein the controller corrects the control deviation of the deflector based on the difference.

3. The distance measurement apparatus according to claim 1,
wherein the light receiving sensor has a plurality of light receiving units, each of which is the smallest unit of light reception, and
wherein the controller detects the actual light entrance position based on the positions of each of the plurality of light receiving units.

4. The distance measurement apparatus according to claim 1,
wherein the controller detects the deviation of the deflector based on the difference between the reference light entrance position assumed for the rotation angle being set on the deflector that is included within two angle ranges that do not overlap each other and the actual light entrance position obtained for the rotation angle included within the two angle ranges.

5. The distance measurement apparatus according to claim 4,
wherein a part of each of the two angle ranges is set to an angle that falls outside a measurement range during normal operation, and
wherein the apparatus further comprises a fixed mirror that reflects the laser beam deflected by the deflector, which is set to the rotation angle of an angle outside the measurement range during normal operation so as to fold back the laser beam within the measurement range.
